(19) United States
(12) Patent Application Publication
(10) Pub. No.: US 2013/0105599 A1
(43) Pub. Date: May 2, 2013

(54) COSMETIC SPRAYER

(71) Applicant: WEI-HAO CHEN, Kaohsiung City (TW)

(72) Inventor: WEI-HAO CHEN, Kaohsiung City (TW)

(21) Appl. No.: 13/282,194

(22) Filed: Oct. 26, 2011

(51) Int. Cl. B05B 11/04

(52) U.S. Cl. 239/329

(57) ABSTRACT

A sprayer includes a flexible ball for receiving perfume or powder therein and an outer part is mounted to the flexible ball. A nozzle unit is engaged with the opening of the flexible ball and the top hole of the outer part. The nozzle unit includes a body which has a passage defined therethrough. A connector has a groove defined in the first end thereof which is inserted into the opening of the flexible ball and the inner periphery of the opening of the flexible ball is engaged with the groove. The second end of the connector extends beyond the opening of the flexible ball and is threadedly connected to the body. A mounting part is mounted to the body and the second end of the connector. The mounting part has a flange which presses the periphery of the top opening of the outer part against the connector.

### FIELD OF THE INVENTION

The present invention relates to a sprayer, and more particularly, to a cosmetic sprayer wherein the outer part is well secured and the sprayer is easily assembled.

### BACKGROUND OF THE INVENTION

A conventional cosmetic sprayer generally includes a flexible and hollow ball and a container with perfume or power received therein. The container includes a cover which has an axial outlet and a radial path which is connected with a hose inserted into the container. A nozzle has a passage which communicates with the outlet and the nozzle is connected between the cover and the flexible ball. An outer part is mounted to the flexible ball. By squeezing the flexible ball and the outer part, the air in the flexible ball is ejected from the passage of the nozzle, and the interior of the flexible ball becomes vacuumed so that the perfume or powder is sucked upward and mixed with the air and ejected from the passage of the nozzle.

However, the relationship between the parts of the sprayer is complicated and a lot of time for assembling the sprayer is required. Besides, the container and the flexible ball are too bulky to be conveniently carried by the users. The way that the nozzle connected to the cover makes the replace or refill of the perfume or powder be difficult to proceed. The users usually discard the sprayers after the perfume or powder is used out.

The outer part is directly connected to the outside of the flexible ball and the opening of the outer part is located at the connection area between the nozzle and the flexible ball. Because the outer part is made by netted or woven material, so that the opening of the outer part is secured by using a rope. Nevertheless, the deformation of the flexible ball after each squeeze, the outer part tends to be loosened and even broken to affect the aesthetic appearance.

The present invention intends to provide a cosmetic sprayer which improves the shortcomings of the conventional cosmetic sprayers.

### SUMMARY OF THE INVENTION

The present invention relates to a sprayer and comprises a flexible ball with an outer part mounted to the outside thereof. The flexible ball has an opening and a space is defined in the flexible ball, the space communicating with the opening. The outer part has a top hole which communicates with the opening of the flexible ball. A nozzle unit has a body, a connector and a mounting part. The body has a passage defined axially therein and a first outer threaded section is connected to the lower end of the body. The connector has a groove defined in the first end thereof which is inserted into the opening of the flexible ball. The inner periphery of the opening of the flexible ball is engaged with the groove. A second outer threaded section and a first inner threaded section are formed on the second end of the connector. The second end of the connector extends beyond the opening of the flexible ball. The first inner threaded section of the connector is threadedly connected to the first outer threaded section of the body. The mounting part is mounted to the lower end of the body and the second end of the connector. The mounting part has a flange which presses the periphery of the top opening of the outer part to the connector. The mounting part has a second inner threaded section which is threadedly connected to the second outer threaded section of the connector.

Preferably, the passage of the body is connected with a hose which is inserted into the space and has an inclined opening defined in a lower end thereof.

Preferably, a cover is mounted to the nozzle unit and has a cone-shaped protrusion extending toward the passage.

Preferably, liquid or powder is received in the space.

Preferably, the outer part is a netted part or woven part.

The flange of the connector presses the outer part so as to prevent the outer part from being damaged. The protrusion of the cover can more securely position the cover to the nozzle unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cosmetic sprayer of the present invention;

FIG. 2 is a perspective view to show the cosmetic sprayer of the present invention;

FIG. 3 is a cross sectional view of the cosmetic sprayer of the present invention;

FIG. 4 is an enlarged cross sectional view to show the connection of the nozzle unit, the cover, the flexible ball and the outer part of the cosmetic sprayer of the present invention;

FIG. 5 is a cross sectional view to show that the flexible ball of the cosmetic sprayer of the present invention is squeezed, and

FIG. 6 is a cross sectional view to show that the flexible ball of the cosmetic sprayer of the present invention is squeezed, wherein a hose is connected with the passage of the nozzle unit.

### DETAILED DESCRIPTION OF THE PREFERRED EMBODIMENT

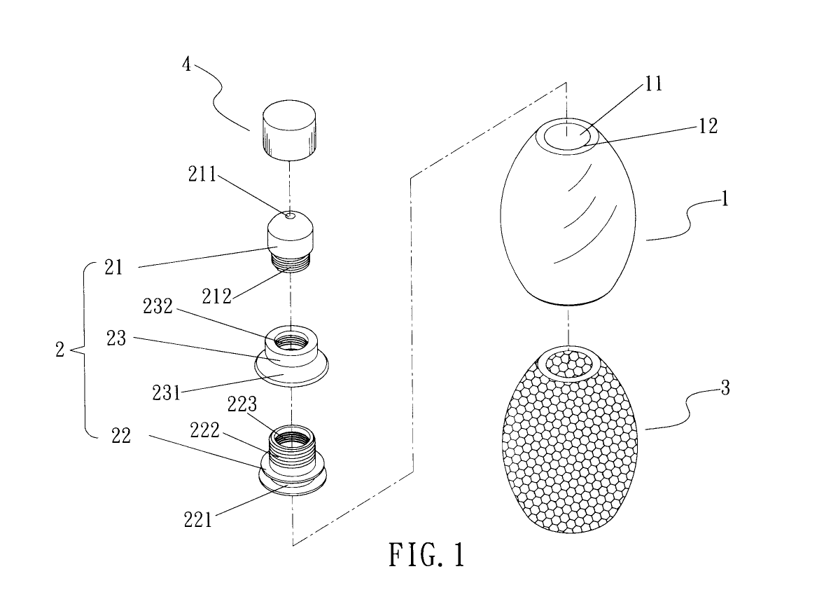

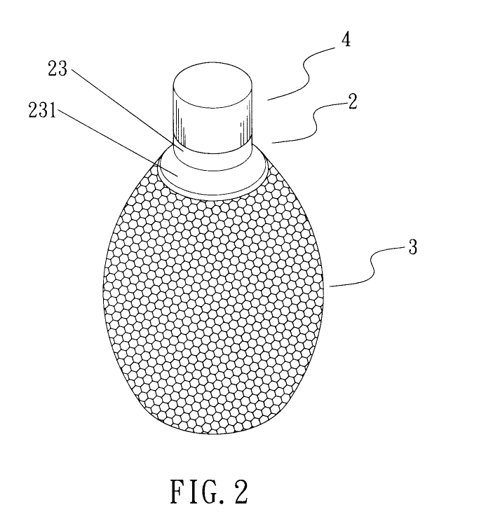

Referring to FIGS. 1 and 2, the cosmetic sprayer of the present invention comprises a flexible ball 1 having an opening 12 and a space 11 is defined in the flexible ball 1. Liquid or powder is received in the space 11 and the space 11 communicates with the opening 12. An outer part 3 is mounted to the flexible ball 1 and is a netted part or woven part. The outer part 3 has a top hole which communicates with the opening 12 of the flexible ball 1.

A nozzle unit 2 comprises a body 21, a connector 22 and a mounting part 23. The body 21 has a passage 211 defined axially therein and a first outer threaded section 212 is connected to a lower end of the body 21. The connector 22 has a radial portion extending outward from the first end thereof and an annular groove 221 is defined in the radial portion. The first end of the connector 22 is inserted into the opening 12 of the flexible ball 1. The inner periphery of the opening 12 of the flexible ball 1 is engaged with the groove 221. A second outer threaded section 222 and a first inner threaded section 223 are formed on the second end of the connector 22. The second end of the connector 22 extends beyond the opening of the flexible ball 1. The first inner threaded section 223 of the connector 22 is threadedly connected to the first outer threaded section 212 of the body 21. The mounting part 23 is mounted to the lower end of the body 21 and the second end of the connector 22. The mounting part 23 has a flange 231 which presses the portion around the top opening of the outer part 3 to the radial portion of the connector 22. The mounting part 23 has a second inner threaded section 232 which is threadedly connected to the second outer threaded section 222 of the connector 22. A cover 4 is mounted to the nozzle unit 2.

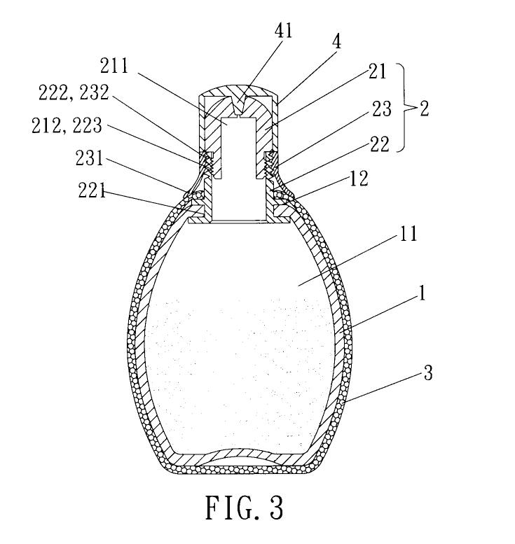

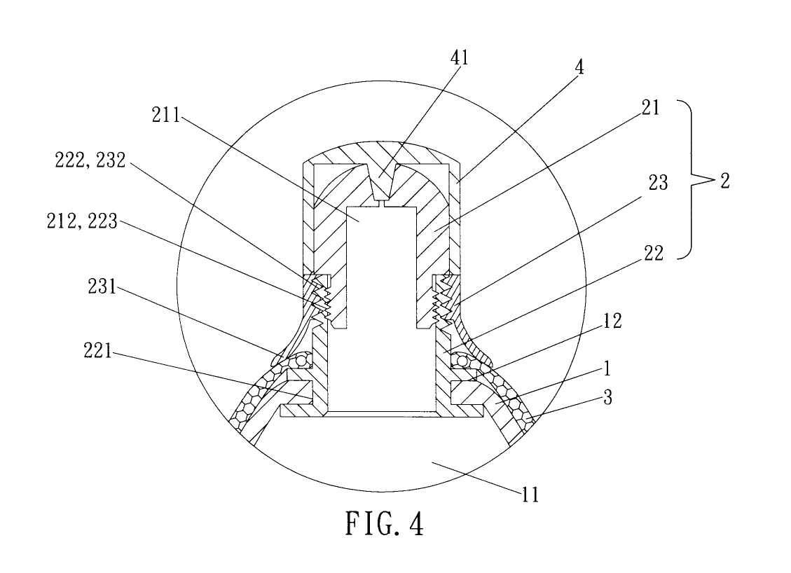

Further referring to FIG. 3, the inner periphery of the opening 12 of the flexible ball 1 is engaged with the groove 221 and the mounting part 23 is connected to the connector 22 by connection of the second inner threaded section 232 and the second outer threaded section 222. The flange 231 of the mounting part 23 presses the outer part 3 against the radial portion of the connector 22. The body 21 is then connected to the connector 22 by the connection of the first outer threaded section 212 and the first inner threaded section 223. The cover 4 is mounted to the body 21 of the nozzle unit 2 and has a cone-shaped protrusion 41 extending toward the passage 211 as shown in FIG. 4.

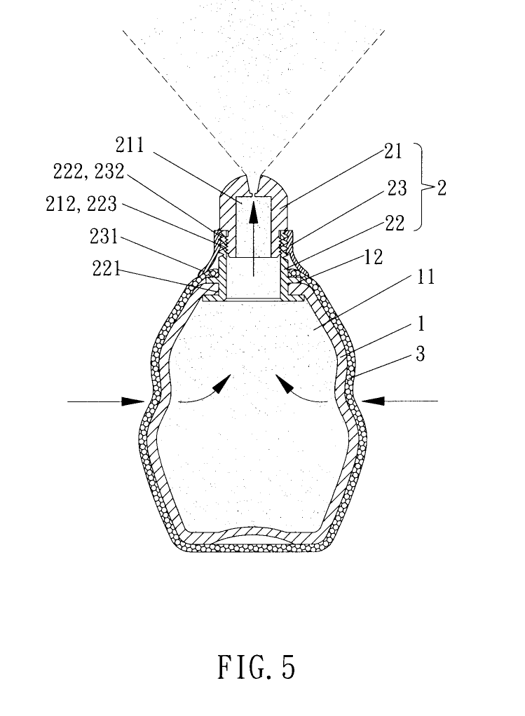

As shown in FIG. 5, when in use, the cover 4 is first removed from the nozzle unit 2 and the flexible ball 1 is squeezed, the liquid such as perfume or the powder is mixed with air and ejected from the passage 211 of the body 21. When releasing the flexible ball 1, the air outside of the sprayer enters the space 11 and the flexible ball 1 inflates as shown in FIG. 3.

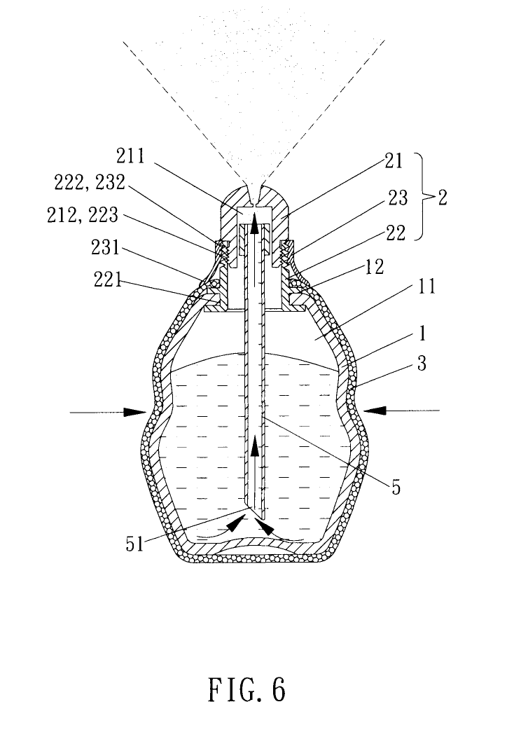

When perfume is received in the space 11, as shown in FIG. 6, the passage 211 of the body 21 is connected with a hose 5 which is inserted into the space 11 and has an inclined opening 51 defined in the lower end thereof so as to suck the perfume perfectly.

The outer part 3 is secured to the sprayer due to the flange 231 of the mounting part 23 pressing the outer part 3 against the radial portion of the connector 22. By the cone-shaped protrusion 41 of the cover 4, the cover does not mounted to the nozzle unit 2 too tight to scrape the surface of the body 21 when removing the cover 4 away, and the cover 4 is well positioned.

The sprayer of the present invention is easily assembled and conveniently carried. The cover is well positioned so that the perfume or powder does not leak.

The structure of the sprayer of the present invention is simplified and the perfume or powder can be refilled.

While we have shown and described the embodiment in accordance with the present invention, it should be clear to those skilled in the art that further embodiments may be made without departing from the scope of the present invention.

What is claimed is:

1. A sprayer comprising:
a flexible ball having an opening and a space defined in the flexible ball, the space communicating with the opening;
an outer part mounted to the flexible ball having a top hole which communicates with the opening of the flexible ball, and
a nozzle unit having a body, a connector and a mounting part, the body having a passage defined axially therein and a first outer threaded section connected to a lower end of the body, the connector having a groove defined in a first end thereof which is inserted into the opening of the flexible ball, an inner periphery of the opening of the flexible ball being engaged with the groove, a second outer threaded section and a first inner threaded section formed on a second end of the connector, the second end of the connector extending beyond the opening of the flexible ball, the first inner threaded section of the connector threadedly connected to the first outer threaded section of the body, the mounting part mounted to the lower end of the body and the second end of the connector, the mounting part having a flange which presses a portion around the top opening of the outer part to the connector, the mounting part having a second inner threaded section which is threadedly connected to the second outer threaded section of the connector.

2. The sprayer as claimed in claim 1, wherein the passage of the body is connected with a hose which is inserted into the space and has an inclined opening defined in a lower end thereof.

3. The sprayer as claimed in claim 1, wherein a cover is mounted to the nozzle unit and has a cone-shaped protrusion extending toward the passage.

4. The sprayer as claimed in claim 1, wherein liquid or powder is received in the space.

5. The sprayer as claimed in claim 1, wherein the outer part is a netted part or woven part.
